(19) United States
(12) Patent Application Publication
(10) Pub. No.: US 2005/0228117 A1
(43) Pub. Date: Oct. 13, 2005

(54) Near infrared radiation curable powder coating composition having enhanced flow characteristics

(76) Inventors: Owen H. Decker, Houston, TX (US); Charles N. Myer, Houston, TX (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/054,464

(22) Filed: Feb. 9, 2005

Related U.S. Application Data
(60) Provisional application No. 60/544,093, filed on Feb. 11, 2004.

(51) Int. Cl. C08K 3/00

(52) U.S. Cl. 524/556; 427/487; 524/589; 524/600

(57) ABSTRACT

A powder coating composition comprising an intimate mixture of: (a) at least one film forming NIR radiation curable resin; (b) 1.0 to 20.0 wt. %, based on total weight of the powder coating composition, of at least one NIR reflecting pigment; and (c) at least one curing agent in an effective amount to cure said powder coating composition; wherein components (a), (b) and (c) are not reacted prior to being mixed together and whereby the powder coating composition is cured by NIR radiation.

### CROSS-REFERENCE TO RELATED APPLICATION

This application claims priority under 35 U.S.C. §119 from U.S. Provisional Application Ser. No. 60/544,093 (filed Feb. 11, 2004), which is incorporated by reference herein as if fully set forth.

### FIELD OF THE INVENTION

This invention is directed to a powder coating composition having enhanced flow characteristic that is curable by NIR (near infrared radiation). In particular, this invention is directed to dark colored epoxy resin based powder coating compositions that are curable by NIR.

### BACKGROUND OF THE INVENTION

Powder coatings have been widely used to coat metal substrates to provide decorative or functional finishes to these substrates. Such widespread use is largely due to the increased economic viability of the powder coating process itself, as well as, the favorable influence of the coating process on the environment. Numerous powder coating formulations and processes have been developed for a variety of different applications. The processes developed thus far for curing powder coatings, however, have required that the powder coating deposited on the substrate first be melted by being heated to a temperature above the glass transition temperature or the melting point of the powder coating formulation. The conventional heat sources that have typically been used to heat the powder coating formulations include, for example, convection ovens, infrared light sources, or combinations of the two.

The melted powder coatings are then cured. In the case of thermal crosslinking systems, the powder coating is typically cured by being heated to a temperature of between 140 and 200° C. for a period of approximately 10 to 30 minutes. The powder coatings are generally cross-linked by addition reactions involving, but not limited to, epoxy, carboxy, or isocyano groups. Furthermore, some powder coatings can be cross-linked by polymerizing double bonds using a free radical mechanism.

The use of elevated temperatures to thermally cure powder coatings has disadvantages; for example, curing with elevated temperatures does not allow for the use of temperature-sensitive surfaces, such as, wood or plastics, and when metal surfaces are used, an elevated energy input is required.

U.S. Pat. No. 6,458,250 shows the use of near infrared radiation (NIR) to cure coatings and U.S. Pat. No. 6,541,078 shows the use of NIR radiation to cure powder coatings applied to non-metallic substrates. The term “NIR radiation”, as used herein, means wavelengths of the high intensity radiation ranges from 760 to 1500 nm. There are, however, several disadvantages associated with the use of NIR radiation for curing black powder coatings compositions. Carbon black, which is commonly used in black or dark colored powder coating compositions, absorbs NIR radiation and causes the powder coating to reach its curing temperature before the powder coating can completely flow out and wet the surface to which it has been applied. The result is a finish that has, for example, excessive orange peel and/or unacceptable smoothness and gloss.

This invention is directed to a novel powder coating composition that is curable with NIR radiation is useable on heat sensitive substrates and forms finishes that have significantly reduced orange peel, excellent smoothness and good gloss.

### SUMMARY OF THE INVENTION

The present invention comprises a powder coating composition comprising an intimate mixture of:
(a) at least one film forming NIR radiation curable resin;
(b) 1.0 to 20.0 wt. %, based on total weight of the powder coating composition, of at least one NIR reflecting pigment; and
(c) at least one curing agent in an effective amount to cure said powder coating composition;
   wherein components (a), (b) and (c) are not reacted prior to being mixed together.

### DETAILED DESCRIPTION OF THE INVENTION

The features and advantages of the present invention will be more readily understood, by those of ordinary skill in the art, from reading the following detailed description. It is to be appreciated those certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both preceded by the word “about.” In this manner, slight variations above and below the stated ranges can be used to achieve substantially the same results as values within the ranges. Also, the disclosure of these ranges is intended as a continuous range including every value between the minimum and maximum values.

All patents, patent applications, and publications referred to herein are incorporated by reference in their entirety.

Surprisingly, it was found that, as a result of the NIR irradiation and curing of the novel powder coating compositions of this invention, based on binder systems capable of free-radical polymerization and cross-linkable by addition and/or condensation reactions with NIR radiation, coatings are obtained that have improved flow and cure rapidly and completely and form smooth and high gloss finishes.

The NIR radiation used according to the invention is infrared radiation in the wave length range from about 760 to about 1500 nm, preferably, 760 to 1200 nm. Radiation sources for NIR radiation include, for example, NIR radiation emitters that are able to emit radiation as a flat, linear or point source. NIR radiation emitters of this kind are available commercially (for example, from Adphos). These include, for example, high performance halogen radiation emitters with an intensity (radiation output per unit area) of generally more than 10 kW/m² to, for example, 15 MW/m², preferably from 100 kW/m² to 1000 kW/m². For example, the radiation emitters reach a radiation emitter surface temperature (coil filament temperature) of more than 2000° K, preferably, more than 2900° K, e.g., a temperature from 2000 to 3500° K. Suitable radiation emitters have, for example, an emission spectrum with a maximum between 760 and 1200 nm. Typically, the total time period the composition is irradiated is, for example, within a range from 0.5 to 300 seconds, preferably, from 1 to 30 seconds.

The novel powder coating composition contains 40 to 90 wt. %, preferably, 60 to 90 wt. %, of at least one film forming NIR radiation curable resin, such as an epoxy resin, a polyester resin, urethane resin, acrylic resin, epoxy polyester resin, or a silicone resin; 2 to 50 wt. %, of a curing agent, 1 to 50 wt. %, preferably; 1 to 40 wt. %, of pigments and/or fillers, which include 1 to 20 wt. %, preferably; 3 to 20 wt. % of at least one NIR reflecting pigment; 5 to 15 wt. %, preferably, 0.1 to 1 wt. % of crosslinking catalysts and optionally, further auxiliary substances and additives. All of the above wt. % are based on the total weight of the novel powder coating composition.

The above NIR radiation curable resins contain epoxy, OH, COOH, and RNH as functional groups that form bonds. One particularly useful resin comprises and epoxy resin of epichlorohydrin and bis phenol A having an epoxide equivalent weight of 200 to 2500. Another useful resin comprises at least 50 wt. % of a polyester type resin. Suitable crosslinking resins that can be used include, but are not limited to, di- and/or polyfunctional carboxylic acids, dicyandiamide, phenolic resins, amino resins and/or isocyanates.

The powder coating compositions of this invention contain conventional binder curing agents, such as, low molecular weight polyester resins, epoxy and/or hydroxy alkyl amide curing agents, and/or dimerized isocyanates, dicyandiamide curing agents, carboxylic acid curing agents or phenolic curing agents, or also epoxy-functionalized acrylate resins with carboxylic acid or carboxylic anhydride curing agents.

Examples of curing agents according to the invention for epoxy resins are curing agents containing carboxyl groups, those containing amide and/or amine groups, for example, dicyandiamide and the derivatives thereof, carboxylic acids as well as phenolic resins.

The novel powder coating composition of this invention contains 1 to 50 wt. % of pigment to provide color to the composition which may be conventional organic or inorganic pigments including carbon black or dyes as well as metallic and/or non-metallic special effect imparting agents. However, to provide even curing to form a smooth glossy finish 1 to 20 wt. %, based on the weight of the powder coating composition, of the pigment is at least one NIR reflective pigment. Such pigments reflect between 1% and 80% of the NIR radiation depending on the specific wavelength. The NIR reflecting characteristics of the pigments was taken from manufacturers' literature.

Typically useful NIR reflective pigments that can be used to form the novel powder coating composition of this invention are as follows:
“Artic” Pigments—Black 376, Black 411 and Black 1 0C909 manufactured by Shepherd Color Company, Cincinnati, Ohio and
“Eclipse” pigments—Black 10201 and Black 10202 manufactured by Ferro Corporation, Cleveland, Ohio.
“Artic” pigments—Black 376, Black 411 and Black 10C909 are pigments synthesized by high temperature calcination of inorganic materials.
“Eclipse” pigments—Black 10201 and Black 10202 are also pigments synthesized by high temperature calcination of inorganic materials.

The powder coating compositions according to the invention may contain as further components the constituents conventional in powder coating technology, such as degassing auxiliaries, flow-control agents, flatting agents, texturing agents and light stabilizers. The powder coating composition preferably contains the crosslinking catalysts described above in the stated quantity range. The quantity of additives is for example 0.01 to 10 wt. %, based on the weight of the powder coating composition.

The powder coatings usable, according to the invention, may be produced in a conventional manner, for example, using non-extrusion/grinding processes, production of powders by spraying from supercritical solutions, NAD “non-aqueous dispersion” processes or ultrasonic standing wave atomization process or by known extrusion/grinding process.

The powder coatings of this invention have an excellent adhesion to the substrate surface, and, apart from that, improved flow properties and resistance to overheating by the NIR radiation source.

The powder may be applied onto the substrate to be coated using known electrostatic spraying processes, for example, using corona or tribo principle based spray guns or with other suitable powder application processes, for example, application in the form of an aqueous dispersion (powder slurry) or by means of broad band spreading processes. If an aqueous dispersion is used, the NIR radiation may then advantageously be used to remove the water from the dispersion.

The powder coating composition of this invention is particularly suitable for covering and coating metal substrates having thick-walled proportions, for example, having a thickness of 3 mm or more. Substrates that may be used are, for example, metals, such as, aluminum, steel, glass, ceramics as well as wood or plastic surfaces. In particular, especially three-dimensional objects with thick walls may also be coated with the novel powder coating composition of this invention.

The metal substrate surfaces can be covered and coated according to the invention directly, but they can also be pre-coated, e.g., with an inorganic corrosion protection layer by, e.g., phosphating or chrometizing procedures, prior to covering and coating.

The curing of the novel coating composition may be performed discontinuously and continuously. In the case of continuous operation, the coated substrates may, for example, be passed before one or more stationary NIR radiation sources. The NIR radiation source may, however, also be mobile.

NIR irradiation may be used in combination with conventional heat sources, such as infrared radiation or convection ovens, optionally, together with additional reflector systems and/or lens systems in order to intensify the radiation.

Furthermore, functional coatings may also be applied onto tubes, metal components for reinforcing concrete or structural components, and coatings may be applied onto large components which cannot be heated in an oven, for example, steel structures, bridges, ships.

The novel powder coating composition may also be used for high speed coating with powder coating on, for example, metal or film. An example is the coil coating process at coating speeds of, for example, >50 m/min.

The novel powder coating composition of this invention melts and cures in a single process step with short curing times and provides a more uniform coating on the substrates during the melting and curing process. Owing to the simplicity of handling the NIR radiation source, the short curing times and the selective heating of the powder layer and the improved quality of the coating allow the powder coating of this invention to be used in sectors, such as, steel construction (bridges, high-rise buildings, ship-building, industrial plant etc.) where it was hitherto impossible to use powder coating methods due to the large size of the objects to be coated.

### EXAMPLES

The present invention is further defined in the following Examples. It should be understood that these Examples are given by way of illustration only. From the above discussion and these Examples, one skilled in the art can ascertain the essential characteristics of this invention, and without departing from the spirit and scope thereof, can make various changes and modifications of the invention to adapt it to various uses and conditions. As a result, the present invention is not limited by the illustrative examples set forth herein below, but rather is defined by the claims contained herein below.

### Example 1

The following powder coating compositions 1-3 were prepared by charging the constituents into an extruder and grinding and sieving the resulting blend of constituents to form a sprayable powder coating composition:

| Code | Description | 1 | 2 | 3 |
|---|---|---|---|---|
| RS2530 | Crylcoat ® 340 (UCB) | 50.00 | 50.00 | 50.00 |
| RE1515 | Epon ® 2002 (Resolution, | 50.00 | 50.00 | 50.00 |
| | Type 2 Epoxy) | | | |
| AR1060 | Modaflow ® 6000 (Synthron) | 1.30 | 1.30 | 1.30 |
| CX1060 | Oxymelt A4 (Estron) | 1.00 | 1.00 | 1.00 |
| CW2011 | Castorwax ® (Caschem) | 1.00 | 1.00 | 1.00 |
| DB1011 | Raven 450 Black pigment | 1.25 | | |
| | (Columbia) | | | |
| DE2200 | Bartex ® 80 filler (Hitox) | 5.00 | | |
| | Shepherd 10C909 | | 16.00 | |
| | Ferro Eclipse Black 10201 | | | 12.00 |
| Extruder/RPM | ZSK/300 | | | |
| Zone ½ ° C. | 60/60 | | | |
| Grinder/Screen | Bantam/0.1 | | | |
| Sieve Size | 80 | | | |

Epon® 2002 is a bisphenol-A based resin with glycidyl functional groups, with an epoxide equivalent weight of 675-760 eq./g manufactured by Resolution Performance Products, LLC, Houston, Tex. Crylcoat®) 340 is a carboxy-functional polyester-based resin with an acid value of 71 manufactured by UCB Chemical Corp., Smyrna, Ga. Modaflow® 6000 is a flow-enhancing additive manufactured by the Signet Chemical Corp., Mumbai, India. Oxymelt A4 is an additive designed to promote degassing of the film, manufactured by Estron Chemical Inc., Calvert City, Ky. Castorwax® is a hydrogenated castor oil derivative manufactured by Caschem Inc., Bayonne, N.J. Raven 450 is a carbon black pigment produced by Columbian Chemicals Company, Marietta, Ga. Bartex® 80 is a barium sulfate material, produced by TOR Minerals International, Inc., Corpus Christi, Tex.

All of the above compositions 1-3 formulations used in this example were converted into powder coatings via a conventional technique used to form powder coating compositions. That is, the constituents of each coating formulation were intensively mixed in a ZSK twin-screw extruder operated at 300 rpm and wherein each zone was at 60° C. The extrudate was ground in a Bantam grinder and sieved using an 80-mesh screen. The resulting powder coating composition had a particle size ranging from 2 μm to 250 μm, with an average particle size of 75 μm. The powder coatings were then applied electrostatically with a Corona powder spray gun in identical film thicknesses to ¼″×4″×4″ steel panels. The panels were then exposed to NIR radiation (760 nm to 1200 nm) using NIR super burn emitters at 50% power for 50-70 seconds, resulting in an energy density of 450 kW/m². The NIR emitters are tungsten-filament lamps, 25 cm in length, ranging from 250 W (“Low Burn”) to 2000 W (“Super Burn”). The lamps are arranged in an array, which was raised 75 mm above the steel panels for this test. The NIR emitters and equipment are supplied the Adphos Inc., of Germany.

Powder coating composition 1 was a comparative composition formulated with carbon black pigment. The powder coating beaded up on the panel and did not cover the panel and had an unacceptable appearance. Powder coating composition 2-3 formed smooth and even finishes that covered the entire panel and had an acceptable appearance.

1. A powder coating composition comprising an intimate mixture of:
(a) at least one film forming NIR radiation curable resin;
(b) 1.0 to 20.0 wt. %, based on total weight of the powder coating composition, of at least one NIR reflecting pigment; and
(c) at least one curing agent in an effective amount to cure said powder coating composition;
wherein components (a), (b) and (c) are not reacted prior to being mixed together.

2. The powder coating composition of claim 1 wherein the NIR radiation curable resin is from the group of epoxy resins, polyester resins, urethane resins, acrylic resins, epoxy polyester resins, or silicone resins.

3. The powder coating composition of claim 2 wherein the NIR radiation curable resin comprises an epoxy resin.

4. The powder coating composition of claim 3 wherein the NIR reflecting pigment comprises a black pigment that reflects between 1% and 80% of the NIR radiation.

5. The powder coating composition of claim 4 wherein the epoxy resin comprises epichlorohydrin and bis phenol A having an epoxide equivalent weight of 200 to 2500.

6. The powder coating composition of claim 5 wherein the curing agent for the epoxy resin comprises an amine curing agent

7. The powder coating composition of claim 2 wherein the NIR radiation curable resin system is comprised of at least 50% by weight of polyester-type resin.

8. The powder coating composition of claim 1 comprising an intimate mixture of
(a) an epoxy resin of epichlorohydrin and bis phenol A having an epoxide equivalent weight of 200 to 2500,
(b) 1-20% by weight, based on the weight of the powder coating composition, of pigments comprising an NIR reflecting pigment that reflects between 1 and 80% of the NIR radiation.

9. A substrate coated with a cured layer of the composition of claim 1.

10. A process for applying the powder coating composition of claim 1 to a substrate and curing the composition with NIR radiation.
